(19) United States
(12) Patent Application Publication
(10) Pub. No.: US 2014/0268011 A1
(43) Pub. Date: Sep. 18, 2014

(54) MAGNETICALLY-BIASED EYEGLASSES

(71) Applicant: DYE PRECISION, INC., (US)

(72) Inventors: Kevin Patrick Larmer, San Marcos, CA (US); Brian Douglas Currens, La Jolla, CA (US)

(21) Appl. No.: 13/800,893

(22) Filed: Mar. 13, 2013

(51) Int. Cl. G02C 5/14

(52) U.S. Cl. CPC G02C 5/14
USPC 351/121

(57) ABSTRACT

This disclosure provides a mechanism for magnetically biasing a pair of eyeglasses between open and closed configurations. Magnetic material on the frame front and magnetic material on the temples create a magnetic interaction that biases the eyeglasses toward an open or closed configuration. The magnetic interaction may be attractive, repulsive, or a combination of the two. The mechanism may provide a bias in all eyeglass configurations or only in select ranges of configurations.

### BACKGROUND

1. Field

This disclosure relates generally to eyeglasses. More particularly, features configured for facilitating the movement of eyeglass temples between open and closed configurations are disclosed.

2. Description of the Related Art

Eyeglasses can be difficult to open due to stiffness or resistive forces in the hinges. This difficulty is especially hard for frail or weak eyeglass wearers. It also creates difficulty for those who deal with eyeglasses on a daily or even hourly basis, such as eyeglass vendors or manufacturers.

It is common to facilitate the opening of a pair of eyeglasses using mechanical components. Such components include cams, springs, bifurcated flanges, ball and socket, or pawls. It is also common to facilitate the opening of eyeglasses using materials with elastic or resilient properties. Such components and materials facilitate opening with various mechanisms, including bending stresses, friction, or interferences between parts.

Use of such mechanical methods for facilitating the opening of eyeglasses can wear the parts over time. For instance, friction or interference methods will likely lead to wear of features essential for facilitating the opening. One potential risk is that they will lose some or all of their ability to facilitate opening.

Further, such methods typically require two hands to open the eyeglasses. This is an obvious disadvantage for those who want to wear eyeglasses but can't use both hands. For instance, an amputee who has lost his hand or arm would have difficulty with eyeglasses employing such mechanical methods or materials.

These mechanical means for facilitating the opening of eyeglasses also require more parts. The addition of more parts increases complexity and thus leads to a higher risk of eventual malfunction.

Thus, a need exists for a means to facilitate the opening of eyeglasses that overcomes the aforementioned shortcomings.

### SUMMARY

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description of Certain Embodiments,” one will understand how the features of the embodiments described herein provide advantages over existing eyeglasses.

An aspect of the present invention involves a pair of eyeglasses comprising a frame front having at least one first magnet and at least one temple having at least one second magnet. The at least one second magnet is disposed relative to the at least one first magnet to create a magnetic interaction that biases the at least one temple to rotate in a direction away from the frame front.

In some forms of this aspect, the magnetic interaction is an attractive force, a repulsive force, or a combination of both an attractive and a repulsive force.

A preferred form of these aspects of the present invention involves the creation of a magnetic interaction when the eyeglasses are in select configurations. In some embodiments, the magnetic interaction is created when the temple is rotated relative to the frame front by an amount equal to or greater than a magnetization angle, which may be about 15, 30, 45 or 60 degrees, or any other angle in between an open and closed eyeglass configuration. In one embodiment, the magnetic interaction is created when the eyeglasses are in a closed configuration. In another embodiment, the magnetic interaction is created when the eyeglasses are in an open configuration.

Another aspect of the present invention involves the eyeglasses having at least one second magnet disposed in different locations of the temple. Some embodiments of this aspect involve a temple further comprising a proximal end and a distal end, wherein the at least one second magnet is disposed on the temple at the proximal end, between the proximal and the distal ends, or at the distal end.

An additional aspect of the present invention involves the eyeglasses having at least one first magnet in different locations of the frame front. Some embodiments of this aspect involve a frame front further comprising a bridge portion, a lens retaining portion, and an outer portion, wherein the at least one first magnet is disposed on the outer portion. In another embodiment, a first magnet is disposed on the lens retaining portion. In other embodiments, a first magnet is disposed on the bridge portion.

Another aspect is eyeglasses having a frame front having at least one first member and at least one temple having at least one second member. The at least one second member is disposed relative to the at least one first member to create a magnetic interaction that biases the at least one temple to rotate in a direction away from the frame front.

Another aspect is eyeglasses having at least one first member and at least one second member. The at least one second member is disposed relative to the at least one first member to create a magnetic interaction that biases the eyeglasses between open and closed configurations.

Another aspect of the present invention involves the eyeglasses wherein the first and second magnets are permanent magnets, ferromagnets, or ferrimagnets.

Without limiting the scope of the invention as expressed by the claims, its more prominent aspects have been discussed briefly above. Further aspects and features will also be understood from the description below.

### BRIEF DESCRIPTION OF THE DRAWINGS

These and other features, aspects and advantages of the present invention will now be described in connection with certain embodiments of the invention, in reference to the accompanying drawings. The illustrated embodiments, however, are merely examples and are not intended to limit the invention. The following are brief descriptions of the drawings.

FIG. 1 is a perspective view schematically illustrating an example of a magnetically-biased pair of eyeglasses according to a preferred embodiment of the present invention.

FIG. 2 is a rear view of the eyeglasses of FIG. 1.

FIG. 3 is a side view of the eyeglasses of FIG. 1.

FIG. 4 is a section view through the eyeglasses of FIG. 3 along line 4-4.

FIG. 5 is a section view through the eyeglasses of FIG. 2 along line 5-5.

FIG. 6 is a close-up schematic illustration of the interface between the temple and the frame from the inside of the eyeglasses.

### DETAILED DESCRIPTION OF CERTAIN EMBODIMENTS

Embodiments of a mechanism for magnetically biasing a pair of eyeglasses between open and closed configurations are disclosed. For example, a pair of eyeglasses can incorporate this feature to bias one or more temples toward an open configuration. The principles of the present invention, however, are not limited to biasing eyeglasses toward an open configuration. For example, a pair of eyeglasses can incorporate this feature to bias one or more temples toward a closed configuration or toward some intermediate configuration between open and closed. Further, it will be understood by one of ordinary skill in this art, in view of the present disclosure, that the present invention may also be used with other types and styles of eyeglasses, including but not limited to spectacles, sunglasses, laboratory glasses, shades, glares, glints, goggles, spekkies, sun specs, sunnies, smoke spectacles, solar shields, stunna shades, and glecks. The present invention may also be used with different styles of such eyeglasses, including but not limited to sport, aviator, clip-on, flip-up, mirrored, oversized, shutter, teashades, wayfarers, and wrap-around. One skilled in the art may also find additional applications for the features disclosed herein. Thus, the illustrations and descriptions of the mechanism in connection with eyeglasses are merely exemplary of one possible application of the features disclosed herein.

The mechanism according to one aspect of the invention provides for magnetically biasing a pair of eyeglasses toward an open configuration. The bias is achieved by the interaction of a first member with a second member. The first and second members are positioned with respect to each other so that they create a magnetic bias. For example, at least one of the first and second members can be a material or object which produces a magnetic field, such as a magnet. The other member can be another magnet which produces another magnetic field or a material that is attracted or repelled by a magnet. Materials that are attracted or repelled include, for example, iron, nickel, cobalt, some alloys of rare earth metals, and some naturally occurring minerals such as lodestone. Many of these materials are considered ferromagnetic and ferrimagnetic materials.

Thus, in embodiments disclosed herein where the first and second members are described as magnets; one of the first or second members can be replaced with a material that is magnetically attracted or repelled and still fall within the scope of the invention. In such embodiments, the first and second members still provide the magnetic bias even though both members may not be magnets. The first and second members can be disposed at various locations on the eyeglasses.

In certain embodiments, the mechanism comprises at least one first magnet or member disposed on a frame front of eyeglasses and at least one second member (magnet or material that is attracted or repelled by the first magnet) disposed on a temple of the eyeglasses. The members create at least one magnetic interaction that biases the eyeglasses toward an open configuration. Of course the locations of the first magnet and the second magnet or material can be switched so that the first magnet is on the temple. In a preferred embodiment, the interaction created by the magnets comprises an attractive force. In other embodiments, the interaction created by the magnets comprises a repulsive force. In some embodiments, multiple interactions created by the magnets comprise both attractive and repulsive forces. Such freedom of arrangements allows for varying the amount of biasing force depending on the angle between the frame front and a temple. Further, the first and second members need not be only a portion of the frame front or temple and can instead be the entire frame front or temple.

The mechanism according to one aspect of the invention provides the magnetic interaction when the eyeglasses are in certain configurations or ranges of configurations. In a preferred embodiment, the magnetic interaction is created after the eyeglasses have been opened slightly. In this embodiment, the magnetic interaction is created when the frame front and the temple, from a closed configuration, have rotated relative to each other by a certain angular displacement, called the magnetization angle. One form of this embodiment creates a magnetic interaction when such angle is greater than or equal to about 15 degrees. This allows for certain uses of the eyeglasses, for example, one-handed opening. Such eyeglasses may be clasped with one hand and shaken slightly to partially open the temples, such that the magnets then bias the eyeglasses toward an open configuration. Having the biasing “kick in” at a certain angle also allows for preserving a closed configuration without having to restrain the temples from opening. For instance, the eyeglasses may be set down alone on a table in a closed configuration without being biased toward an open configuration. Other forms of this embodiment create a magnetic interaction at angles greater than or equal to about 30 degrees, 45 degrees and 60 degrees.

In some embodiments, the magnetic interaction is created while the eyeglasses are in a closed configuration. This embodiment allows for easy opening of the eyeglasses and can be quite useful in certain situations. For example, those wearing gloves such as skiers, snowboarders, gardeners, mechanics, mountain climbers, and others, would benefit greatly from being able to pull a pair of eyeglasses out of their pocket and have it already biased toward an open configuration.

In most embodiments, the magnetic interaction is also created with the eyeglasses in an open configuration, thus creating a locking-type effect. However, in some embodiments, the mechanism may not be biasing the eyeglasses once an open configuration is achieved.

The mechanism according to another aspect of the invention comprises one or more magnets disposed at various locations on or in the various eyeglass components. In one embodiment, the eyeglasses comprise a temple that comprises a proximal end and an opposite distal end, with at least one second magnet or material that is attracted or repelled by the first magnet being at least a portion of the temple at the proximal end. This arrangement allows for a biasing magnetic interaction to be created near a hinge, or the area where the frame front and temple are closest to each other in an open configuration. In this embodiment the magnets would be co-located with both being near the hinge. In other embodiments, at least one second magnet or material is configured with the temple either between the proximal end and the distal end or at the distal end. This provides for creating magnetic interactions at various locations away from the proximal end of the temple. For instance, a repulsive magnetic interaction may be created at the distal end of a temple, creating a moment that biases the temple toward an open configuration.

In another embodiment, the mechanism comprises magnets and/or materials that are attracted or repelled by a magnet at various locations on or in the frame front. This provides for creating magnetic interactions at various locations along the frame front of a pair of eyeglasses. In a preferred embodiment, the frame front comprises a bridge portion, a lens retaining portion and an outer portion, and at least one magnet is configured on or in the outer portion. In one such embodiment, a magnetic interaction comprising attractive forces is created between the magnet at the outer portion of a frame front and a second magnet or material that is magnetically attracted or repelled being located at a proximal end of a temple, creating a moment that biases the eyeglasses toward an open configuration. In another embodiment, a magnetic interaction comprising repulsive forces is created between a first magnet at the outer portion of a frame front and a second magnet at a proximal end of a temple, creating a moment that biases the eyeglasses toward an open configuration. In other embodiments, the first magnet is configured with the frame front at a lens retaining portion or with a bridge portion. In one such embodiment, a repulsive magnetic interaction is created between a first magnet at the bridge portion of the frame front and a second magnet in between the proximal and distal ends of a temple, creating a moment that biases the eyeglasses toward an open configuration.

The mechanism according to another aspect of the invention comprises magnets of different types. In a preferred embodiment, the first and second magnets are permanent magnets. In certain embodiments, the first and second magnets are ferromagnets or ferrimagnets. As explained above, one or more of the magnets can be, for example, a ferromagneticly attracted or repelled material. Thus, the magnetic property of the magnets includes but is not limited to ferromagnetic or ferrimagnetic, and the types of magnets include, but are not limited to, permanent magnets and other magnetic objects or materials.

Certain aspects of the preferred embodiment of the invention are described herein below with reference to the figures.

FIG. 1 schematically illustrates a perspective view of an implementation of a biasing mechanism 100 disposed in a pair of eyeglasses in an open configuration. The eyeglasses are schematically illustrated with a frame front 200 and two temples 300. The temples 300 are rotatably coupled to opposite sides of the frame front 200. The temples 300 may be structurally attached to the frame front 200 in such manner via mechanical hinges or pivots, magnetic hinges or pivots, elastic hinges or pivots, or other suitable attachment means that provide for a rotatable coupling. The biasing mechanism 100 can accommodate any similar attachment means between the frame front 200 and temples 300. As will be further discussed below, the biasing mechanism 100 is illustrated biasing the eyeglasses toward an open configuration via a magnetic interaction, with attractive and/or repulsive forces acting between magnets and/or materials that are attracted or repelled by a magnet and transmitting such forces to the frame front 200 and temples 300 to create the bias toward an open configuration.

FIG. 2 schematically illustrates a rear view of the implementation of the biasing mechanism 100 of FIG. 1. The eyeglasses are schematically illustrated with various components of the frame front 200, including a bridge portion 220, lens retaining portions 230, and outer portions 240. Two temples 300 are also shown. The biasing mechanism 100 is schematically illustrated with parts of the biasing mechanism 100 located at both the outer portions 240 and the temples 300. Further detail of this location of the biasing mechanism 100 will be discussed below with reference to other figures.

The biasing mechanism 100 may also be located in or on the lens retaining portions 230. The lens retaining portion 230 is that part or parts of the frame front 200 in which an eyeglass lens would be installed. The lens retaining portions 230 comprise the areas of the frame front 200 that are approximately in between the outer portions 240 and bridge portion 220. These areas comprise both upper and lower areas of the lens retaining portions 230, i.e. areas that would be above and below a lens installed in the lens retaining portion 230 as viewed from the rear view in FIG. 2. These areas further comprise the side areas of the lens retaining portions 230, i.e. areas that would be to the left and right of a lens installed in the lens retaining portion 230 as viewed from the rear view in FIG. 2. Another way of stating the location of a lens retaining portion 230 is that it comprises all of the area of the frame front 230 that is adjacent to all sides of a lens or lenses installed in a pair of eyeglasses. Multiple lenses may be installed in a single lens retaining portion 230, in which case the lens retaining portion 230 would refer to all areas adjacent to all such lenses. For those eyeglasses where the lenses are integral with the lens retaining portion 230 of a frame front 200, for example with certain laboratory goggles, the lens retaining portion 230 may be defined approximately as that portion of the frame front 200 through which the eye is likely to look through when the eyeglasses are being worn.

The biasing mechanism 100 may also be partially located in or on the bridge portion 220. The bridge portion 220 is that entire part of the frame front 200 that is between the two lens retaining portions 230. This would include the top of the bridge portion 220, as viewed from the rear view of FIG. 2, as well as the bottom of the bridge portion 220 that would sit on the nose of an eyeglass wearer, and the structure in between these two areas.

The locations of any magnets or materials that are attracted or repelled by a magnet in the frame front 200 are not restricted to the rear side or rear surface of the frame front 200. The rear view shown in FIG. 2 is merely for clarity. As will be discussed in more detail below, magnets configured with the frame front 200 at the bridge portion 220, the lens retaining portions 230, and/or the outer portions 240 may be configured in or on the respective parts. Further, such magnets may be located on or toward any side of those respective parts. For example, the magnets may be configured closest to the rear side of the frame front 200 shown in FIG. 2, or they may alternatively, or in addition to, be on the opposite front side of the frame front 200. Magnets configured with the frame front 200 may also be part of any lenses held by the lens retaining portion 230. For example, magnetized lenses or lenses with magnets may provide the magnetizing interaction to create the bias toward an open configuration.

FIG. 3 schematically illustrates a side view of the implementation of the biasing mechanism 100 of FIG. 1. Illustrated are an outer portion 240, a proximal end 320, and a distal end 330. The outer portion 240 is part of the frame front 200. The proximal end 320 and distal end 330 are part of the temple 300. The biasing mechanism 100 is configured with first and second members at the outer portion 240 and at the proximal end 320. The first and second members can be magnets and/or materials that are attracted or repelled by a magnet. In other embodiments, the members in the temple 300 are located at the distal end 330. In other embodiments, members in the temple 300 are located at an area between the proximal end 320 and distal end 330. Members in the temple 300 may further be located in any combination of these various areas of the temple 300. This provides for an arrangement of the first and second members in the biasing mechanism 100 to create the needed magnetic interaction. For example, if a frame front 200 contains the first member in the bridge portion 220, then the second member in the temple 300 will likely, but not necessarily, be located in the area in between the proximal end 320 and distal end 330 to create the requisite magnetic interaction to bias the eyeglasses toward an open configuration.

In the embodiments shown in FIGS. 2 and 3, the first and second members of the biasing mechanism 100 are magnets and/or materials that are attracted or repelled by a magnet and are located at an outer portion 240 and at a proximal end 320. To more clearly see the positioning of the first and second members in this embodiment, two section cuts have been taken to show section views. As shown in FIG. 2 by line 5-5, a section cut through temple 300 and outer portion 240 has been taken, and the resulting section view is shown in FIG. 5 (discussed below). As shown in FIG. 3 by line 4-4, a section cut through the outer portion 240 has been taken, and the resulting section view is shown in FIG. 4 (discussed below).

FIG. 4 is a section view of the implementation of the biasing mechanism 100 of FIG. 1 (taken from the section cut as shown in FIG. 3). The section view of FIG. 4 schematically illustrates an outer portion 240 having one or more first members 210. In certain embodiments, the first member 210 is a magnet and/or a material that is attracted or repelled by a magnet. The first members 210 are shown as having circular cross-sections, but they may have any cross-sectional shape. Corresponding second members 310 (shown in FIG. 5 and discussed below) are disposed with respect to the first members 210 to create a magnetic interaction that biases the eyeglasses toward an open configuration. First members 210 are shown embedded within outer portion 240. However, first members 210 may also be in various other locations of outer portion 240, including partially embedded in or on an outer surface of outer portion 240, or in any other suitable locations.

FIG. 5 is a section view of the implementation of the biasing mechanism 100 of FIG. 1 (taken from the section cut as shown in FIG. 2). The section view of FIG. 5 schematically illustrates the first members 210 configured with outer portion 240 and the second members 310 configured with proximal end 320. In this embodiment, the first member 210 and the second member 310 are approximately aligned and magnetically interact via attractive forces to bias the eyeglasses toward an open configuration. The first member 210 and second member 310 are shown embedded, respectively, in outer portion 240 and proximal end 320. However, in other embodiments the members may be only partially embedded in or on the outer surfaces of their respective parts.

FIG. 6 is a close-up view of the implementation of the biasing mechanism 100 of FIG. 1. Schematically illustrated are the embedded first members 210, lens retaining portion 230, the outer portion 240, the embedded second members 310, and the proximal end 320. First members 210 are shown embedded in outer portion 240 and second members 310 are shown embedded in proximal end 320 by the dotted lines. Thus, the first and second members 210, 310 themselves are not visible. Rather, the first and second members 210, 310 are embedded inside their respective areas and their locations are identified in FIG. 6 with hidden (dashed) lines.

However, the first and second members 210, 310 may be arranged in any number of locations and orientations. For example, the first and second members 210, 310 need not be fully embedded or embedded at all in their respective locations. There may further be more or less than just two first members 210 and more or less than just two second members 310. Also, there need not be a matching quantity of first members 210 and second members 310. For example, there may be a larger or smaller quantity of first members 210 compared to the quantity of second members 310. The first and second members 210, 310 are also shown aligned; however they need not be aligned. For example, the first and second members 210, 310 may be staggered relative to each other or in any other pattern or positions. In FIG. 6, the first members 210 and the second members 310 are also shown adjacent to each other when the eyeglasses are in an open configuration. However, the first and second members 210, 310 need not be adjacent in an open configuration. The first and second members 210, 310 may also be farther apart in such configuration. For example, FIGS. 5 and 6 illustrate the first and second members 210, 310 touching each other with no part of the outer portion 240 or proximal end 320 disposed between the first and second members 210, 310 in the open configuration. However, there may also be structural material from the outer portion 240 or proximal end 320 in between the first and second members 210, 310 while in the open configuration. FIG. 6 also illustrates the first and second members 210, 310 outside of the hinge that rotatably couples the outer portion 240 and the proximal end 320. However, the first and second members 210, 310 may be anywhere in, on, or around the hinge, whether the hinge is mechanical or otherwise.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. Eyeglasses comprising:
a frame front having at least one first member; and
at least one temple having at least one second member, the at least one second member being disposed relative to the at least one first member to create a magnetic interaction that biases the at least one temple to rotate in a direction away from the frame front.

2. The eyeglasses of claim 1, wherein the magnetic interaction comprises an attractive force.

3. The eyeglasses of claim 1, wherein the magnetic interaction comprises a repulsive force.

4. The eyeglasses of claim 1, wherein the magnetic interaction comprises both an attractive force and a repulsive force.

5. The eyeglasses of claim 1, wherein the magnetic interaction is created when the temple is rotated relative to the frame front by an amount equal to or greater than a magnetization angle.

6. The eyeglasses of claim 5, wherein the magnetization angle is about 15 degrees.

7. The eyeglasses of claim 5, wherein the magnetization angle is about 30 degrees.

8. The eyeglasses of claim 5, wherein the magnetization angle is about 45 degrees.

9. The eyeglasses of claim 1, wherein the magnetic interaction is created when the eyeglasses are in an open configuration.

10. The eyeglasses of claim 1, wherein the magnetic interaction is created when the eyeglasses are in a closed configuration.

11. The eyeglasses of claim 1 wherein the temple further comprises a proximal end and a distal end, and wherein the at least one second member is disposed on the temple at the proximal end.

12. The eyeglasses of claim 11, wherein the at least one second member is disposed on the temple between the proximal end and the distal end.

13. The eyeglasses of claim 11, wherein the at least one second member is disposed on the temple at the distal end.

14. The eyeglasses of claim 1, wherein the frame front further comprises a bridge portion, a lens retaining portion, and an outer portion, and wherein the at least one first member is disposed on the outer portion.

15. The eyeglasses of claim 14, wherein the at least one first member is disposed on the lens retaining portion.

16. The eyeglasses of claim 14, wherein the at least one first member is disposed on the bridge portion.

17. The eyeglasses of claim 1, wherein at least one of the at least one first member and the at least one second member is a permanent magnet.

18. The eyeglasses of claim 1, wherein at least one of the at least one first member and the at least one second member is a ferromagnet.

19. The eyeglasses of claim 1, wherein at least one of the at least one first member and the at least one second member is a ferrimagnet.

20. Eyeglasses comprising at least one first member and at least one second member, the at least one second member being disposed relative to the at least one first member to create a magnetic interaction that biases the eyeglasses between open and closed configurations.
